(19) United States
(12) Patent Application Publication
(10) Pub. No.: US 2023/0209057 A1
(43) Pub. Date: Jun. 29, 2023

(54) BIT RATE CONTROL SYSTEM, BIT RATE CONTROL METHOD, AND COMPUTER-READABLE RECORDING MEDIUM STORING BIT RATE CONTROL PROGRAM

(71) Applicant: Fujitsu Limited, Kawasaki-shi (JP)

(72) Inventors: Tomonori KUBOTA, Kawasaki (JP); Takanori NAKAO, Kawasaki (JP); Yasuyuki MURATA, Shizuoka (JP)

(73) Assignee: Fujitsu Limited, Kawasaki-shi (JP)

(21) Appl. No.: 18/176,734

(22) Filed: Mar. 1, 2023

Related U.S. Application Data
(63) Continuation of application No. PCT/JP2020/038602, filed on Oct. 13, 2020.

(51) Int. Cl. H04N 19/124; H04N 19/152; G06T 7/00

(52) U.S. Cl. CPC H04N 19/124; H04N 19/152; G06T 7/0002; G06T 2207/30168

(57) ABSTRACT

A bit rate control system includes: a memory; and a processor coupled to the memory and configured to: perform an image recognition process on a frame to be processed in video while changing image quality to specify the image quality at which recognition accuracy of an object included in the frame to be processed reaches an allowable limit; calculate a first quantization step that corresponds to the specified image quality; determine whether or not overflow occurs in a virtual buffer when encoding processing is performed on the frame to be processed by using the calculated first quantization step; and exercise control to perform the encoding processing on the frame to be processed by using the calculated first quantization step when the overflow is determined not to occur.

### CROSS-REFERENCE TO RELATED APPLICATION

This application is a continuation application of International Application PCT/JP2020/038602 filed on Oct. 13, 2020 and designated the U.S., the entire contents of which are incorporated herein by reference.

### FIELD

The embodiments discussed herein are related to a bit rate control system, a bit rate control method, and a bit rate control program.

### BACKGROUND

When video data is encoded and transmitted, bit rate control is commonly exercised according to transmission load. For example, in a case of a variable bit rate (VBR) mode, a bit rate according to a scene is assigned to each piece of frame data of the video data.

U.S. Patent Application Publication No. 2019/0266490, U.S. Patent Application Publication No. 2019/0335192, U.S. Patent Application Publication No. 2019/0220700, U.S. Patent Application Publication No. 2020/0143457, and Japanese National Publication of International Patent Application No. 2020-508010 are disclosed as related art.

### SUMMARY

According to an aspect of the embodiments, a bit rate control system includes: a memory; and a processor coupled to the memory and configured to: perform an image recognition process on a frame to be processed in video while changing image quality to specify the image quality at which recognition accuracy of an object included in the frame to be processed reaches an allowable limit; calculate a first quantization step that corresponds to the specified image quality; determine whether or not overflow occurs in a virtual buffer when encoding processing is performed on the frame to be processed by using the calculated first quantization step; and exercise control to perform the encoding processing on the frame to be processed by using the calculated first quantization step when the overflow is determined not to occur.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a first diagram illustrating an exemplary system configuration of a video transmission system;

FIG. 2 is a diagram illustrating an exemplary hardware configuration of a bit rate control system;

FIG. 3 is a first diagram illustrating an exemplary functional configuration of an image processing device;

FIG. 4 is a diagram illustrating a specific example of image processing performed by the image processing device;

FIG. 5 is a first diagram illustrating an exemplary functional configuration of a control device;

FIG. 6 is a first flowchart illustrating a flow of a bit rate control process;

FIG. 7 is a second flowchart illustrating a flow of the bit rate control process;

FIG. 8 is a diagram illustrating exemplary transitions of a virtual buffer position;

FIG. 9 is a diagram illustrating an exemplary functional configuration of an encoder;

FIG. 10 is a diagram illustrating details of an information amount prediction unit of the control device;

FIG. 11 is a second diagram illustrating an exemplary system configuration of the video transmission system;

FIG. 12 is a second diagram illustrating an exemplary functional configuration of the image processing device;

FIG. 13 is a second diagram illustrating an exemplary functional configuration of the control device; and

FIG. 14 is a third flowchart illustrating a flow of the bit rate control process.

### DESCRIPTION OF EMBODIMENTS

Meanwhile, in recent years, there have been an increasing number of cases where video data is encoded and transmitted for the purpose of being utilized for an image recognition process by artificial intelligence (AI). Examples of a representative AI model include a model using deep learning or machine learning.

However, according to existing encoding processing, bit rate control is exercised in such a manner that image quality of video data is maintained to a maximum extent within a range in which no overflow occurs in a virtual buffer. Thus, according to the existing encoding processing, areas not needed for the image recognition process using AI may be transmitted with excessive image quality.

In one aspect, an object is to achieve bit rate control suitable for an image recognition process using AI.

Hereinafter, each embodiment will be described with reference to the accompanying drawings. Note that, in the present specification and the drawings, constituent elements having substantially the same functional configuration are denoted by the same reference sign, and redundant description will be omitted.

### First Embodiment

<System Configuration of Video Transmission System>

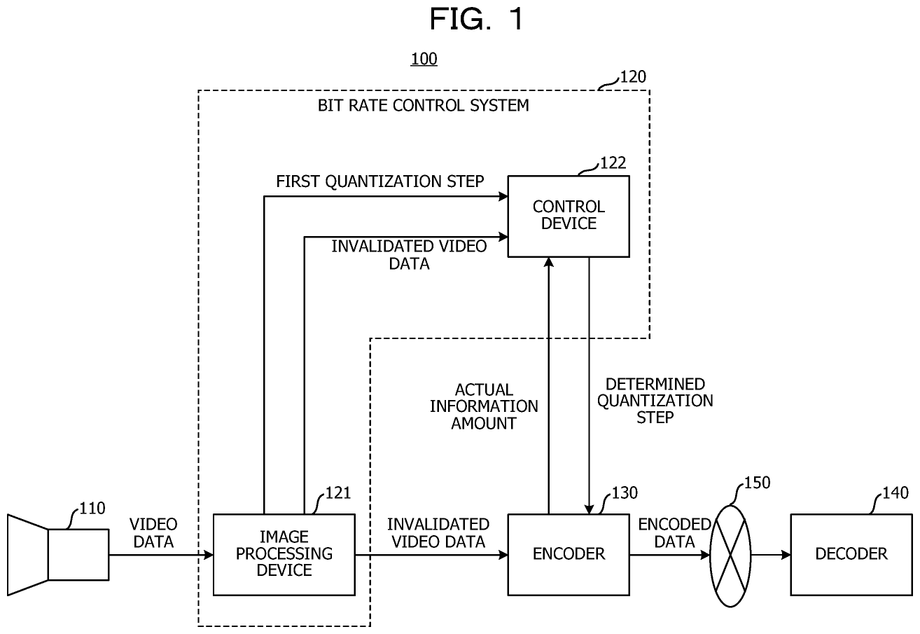

First, a system configuration of an entire video transmission system including a bit rate control system according to a first embodiment will be described. FIG. 1 is a first diagram illustrating an exemplary system configuration of the video transmission system.

As illustrated in FIG. 1, a video transmission system 100 includes an imaging device 110, a bit rate control system 120, an encoder 130, and a decoder 140. In the video transmission system 100, the encoder 130 and the decoder 140 are communicably coupled to each other via a network 150.

The imaging device 110 performs imaging at a predetermined frame period, and transmits video data to the bit rate control system 120. Note that each piece of frame data of the video data is assumed to include an object to be subject to an image recognition process using AI.

The bit rate control system 120 includes an image processing device 121 and a control device 122. Note that the image processing device 121 and the control device 122 may be formed as an integrated device, or may be formed as separate devices.

The image processing device 121 performs an image recognition process on the frame data to be processed in the video data, thereby specifying an object area included in the frame data to be processed and an area other than the object area. Furthermore, the image processing device 121 notifies the control device 122 and the encoder 130 of invalidated video data in which the area other than the object area is invalidated.

Furthermore, the image processing device 121 performs the image recognition process on the frame data to be processed in the video data while changing the image quality, thereby specifying the image quality at which recognition accuracy of an object included in the frame data to be processed reaches an allowable limit. Furthermore, the image processing device 121 calculates a first quantization step corresponding to the specified image quality. Moreover, the image processing device 121 notifies the control device 122 of the calculated first quantization step.

Note that the first quantization step corresponding to the allowable limit image quality indicates a quantization step used in encoding processing when the following items are comparable:
Of the image quality of processed frame data generated by performing filtering processing and the like on the frame data to be processed, the image quality at which the recognition accuracy of the object reaches the allowable limit; and
Image quality of decoded data generated by performing the encoding processing on the frame data to be processed and performing decoding processing on the encoded data.

The control device 122 obtains, from the encoder 130, the information amount (actual information amount) of the encoded data measured when the encoder 130 performs the encoding processing on the previous processing target frame data of the invalidated video data.

Furthermore, the control device 122 calculates a “virtual buffer position” indicating the current virtual buffer remaining amount based on the obtained actual information amount, and predicts a change of the virtual buffer position when the encoding processing is performed on the frame data to be processed using the first quantization step.

Furthermore, the control device 122 determines whether or not overflow occurs in the virtual buffer based on the prediction result of the changed virtual buffer position. Furthermore, when the control device 122 determines that no overflow occurs, it determines to perform the encoding processing on the frame data to be processed using the first quantization step.

Furthermore, when the control device 122 determines that overflow occurs, it calculates a second quantization step that may avoid overflow occurrence even when the encoding processing is performed on the frame data to be processed at the current virtual buffer position. In this case, the control device 122 determines to perform the encoding processing on the frame data to be processed using the second quantization step.

Moreover, the control device 122 notifies the encoder 130 of the quantization step (determined quantization step) determined as the quantization step to be used at the time of performing the encoding processing on the frame data to be processed. As a result, the control device 122 is enabled to control the encoder 130 to perform the encoding processing using the determined quantization step.

The encoder 130 performs the encoding processing on the frame data to be processed in the invalidated video data using the determined quantization step notified from the control device 122, thereby generating encoded data. Furthermore, the encoder 130 transmits the generated encoded data to the decoder 140 via the network 150.

The decoder 140 performs decoding processing on the encoded data transmitted from the encoder 130, thereby generating decoded data. Note that the image recognition process using AI (not illustrated) is performed on the decoded data generated by the decoder 140.

As described above, in the bit rate control system 120 according to the first embodiment, the following process is performed:
The image quality at which the recognition accuracy when AI performs the image recognition process reaches the allowable limit is specified; and
The bit rate control is exercised using the first quantization step corresponding to the specified image quality when it is determined that no overflow occurs in the virtual buffer.

As a result, according to the bit rate control system 120 according to the first embodiment, it becomes possible to achieve bit rate control suitable for the image recognition process using AI.

<Hardware Configuration of Bit Rate Control System>

Next, a hardware configuration of the bit rate control system 120 will be described. Note that descriptions will be given on the assumption that the image processing device 121 and the control device 122 are formed as an integrated device here.

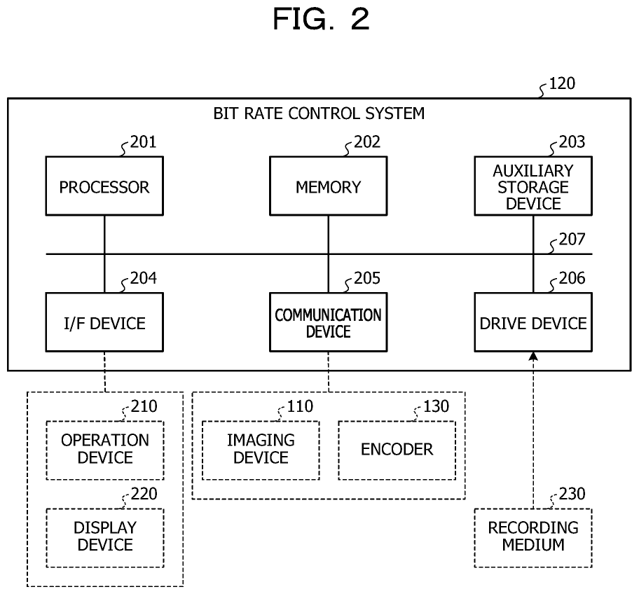

FIG. 2 is a diagram illustrating an exemplary hardware configuration of the bit rate control system. The bit rate control system 120 includes a processor 201, a memory 202, an auxiliary storage device 203, an interface (I/F) device 204, a communication device 205, and a drive device 206. Note that the individual pieces of hardware of the bit rate control system 120 are coupled to each other via a bus 207.

The processor 201 includes various arithmetic devices such as a central processing unit (CPU), a graphics processing unit (GPU), and the like. The processor 201 reads various programs (e.g., bit rate control program to be described later, etc.) into the memory 202, and executes them.

The memory 202 includes a main storage device such as a read only memory (ROM), a random access memory (RAM), or the like. The processor 201 and the memory 202 form what is called a computer, and the processor 201 executes the various programs read into the memory 202 to cause the computer to implement various functions (details of the various functions will be described later).

The auxiliary storage device 203 stores various programs and various types of data to be used when the various programs are executed by the processor 201.

The I/F device 204 is a connection device that couples an operation device 210 and a display device 220, which are exemplary external devices, with the bit rate control system 120. The I/F device 204 receives operations for the bit rate control system 120 through the operation device 210. Furthermore, the I/F device 204 displays a processing result of the bit rate control system 120 through the display device 220.

The communication device 205 is a communication device for communicating with another device. The bit rate control system 120 communicates with the imaging device 110 and the encoder 130 through the communication device 205.

The drive device 206 is a device for setting a recording medium 230. The recording medium 230 mentioned here includes a medium that optically, electrically, or magnetically records information, such as a compact disc read only memory (CD-ROM), a flexible disk, a magneto-optical disk, or the like. Furthermore, the recording medium 230 may include a semiconductor memory or the like that electrically records information, such as a ROM, a flash memory, or the like.

Note that the various programs to be installed in the auxiliary storage device 203 are installed, for example, when the distributed recording medium 230 is set in the drive device 206 and the various programs recorded in the recording medium 230 are read by the drive device 206. Alternatively, the various programs to be installed in the auxiliary storage device 203 may be installed by being downloaded from a network via the communication device 205.

<Functional Configuration of Image Processing Device>

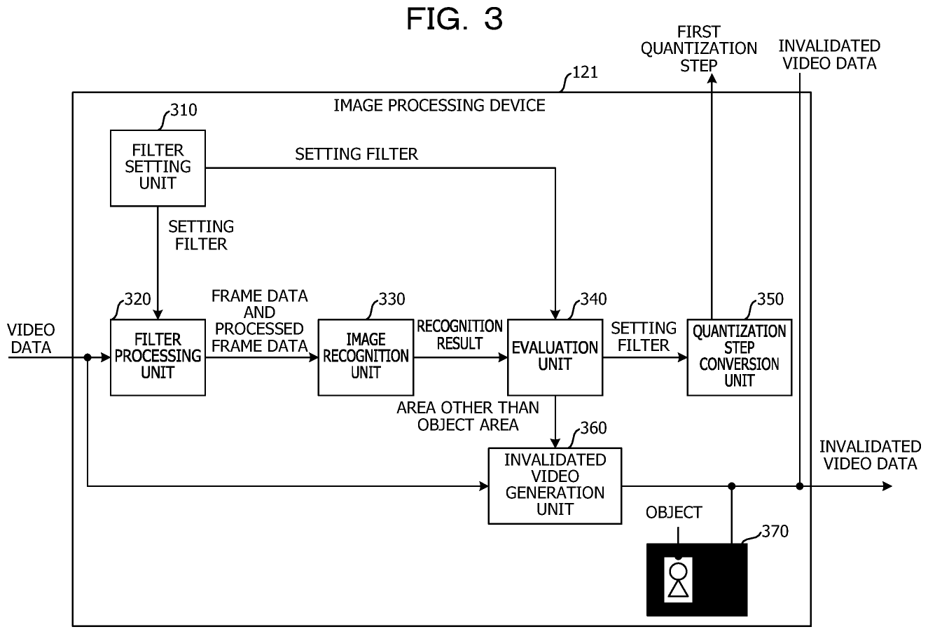

Next, a functional configuration of the image processing device 121 in the bit rate control system 120 will be described. FIG. 3 is a first diagram illustrating an exemplary functional configuration of the image processing device. As described above, a bit rate control program is installed in the bit rate control system 120, and with the program being executed, the image processing device 121 in the bit rate control system 120 functions as the following units:
Filter setting unit 310;
Filter processing unit 320;
Image recognition unit 330;
Evaluation unit 340;
Quantization step conversion unit 350; and
Invalidated video generation unit 360.

Among those units, the filter setting unit 310 sequentially sets setting filters having different levels of processing strength in the filter processing unit 320. The “processing strength” indicates strength of filtering processing that produces a degree of deterioration equivalent to a difference between the following items:
The image quality of the frame data to be processed in the video data ; and
The image quality of the decoded data generated by the decoder 140 performing the decoding processing on the encoded data, which is obtained by the encoder 130 performing the encoding processing on the frame data to be processed using the corresponding quantization step.

Furthermore, the filter setting unit 310 also notifies the evaluation unit 340 of the setting filters sequentially set in the filter processing unit 320.

The filter processing unit 320 notifies the image recognition unit 330 of the frame data to be processed among the individual pieces of frame data of the video data. Furthermore, the filter processing unit 320 sequentially notifies the image recognition unit 330 of processed frame data generated by performing the filtering processing on the frame data to be processed using the setting filters sequentially set by the filter setting unit 310.

The image recognition unit 330 includes a trained model for performing an image recognition process. The image recognition unit 330 performs the image recognition process on the frame data to be processed notified from the filter processing unit 320, and notifies the evaluation unit 340 of a recognition result (including recognition accuracy).

Furthermore, the image recognition unit 330 performs the image recognition process on the processed frame data sequentially notified from the filter processing unit 320, and sequentially notifies the evaluation unit 340 of recognition results (including recognition accuracy).

The evaluation unit 340 is an exemplary specifying unit, and specifies the object area and the area other than the object area included in the frame data to be processed based on the recognition result notified as a result of the image recognition process performed on the frame data to be processed. Furthermore, the evaluation unit 340 notifies the invalidated video generation unit 360 of the specified area other than the object area.

Furthermore, the evaluation unit 340 monitors the recognition accuracy of the object included in the specified object area among the recognition results sequentially notified as a result of the image recognition process performed on the individual pieces of processed frame data, and determines whether or not the recognition accuracy of the object has sharply dropped.

Furthermore, the evaluation unit 340 identifies the setting filter notified from the filter setting unit 310 at the timing immediately before the sharp drop of the recognition accuracy, and notifies the quantization step conversion unit 350 of it.

The quantization step conversion unit 350 is an exemplary first calculation unit, and calculates the first quantization step corresponding to the setting filter identified by the evaluation unit 340.

Furthermore, the quantization step conversion unit 350 notifies the control device 122 of the calculated first quantization step.

The invalidated video generation unit 360 invalidates the area other than the object area for the frame data to be processed. Note that invalidating the area other than the object area indicates setting pixel values of pixels in the area other than the object area to zero among the individual pixels of the frame data to be processed.

The invalidated video generation unit 360 notifies the control device 122 and the encoder 130 of the invalidated video data (e.g., invalidated video data 370) generated by invalidating the frame data to be processed.

<Specific Example of Image Processing by Image Processing Device>

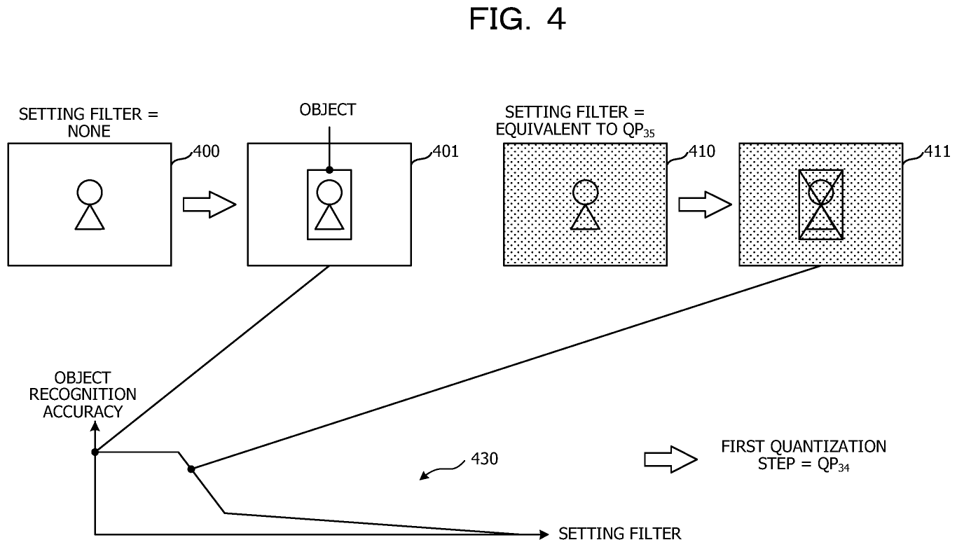

Next, a specific example of image processing performed by the image processing device 121 will be described. FIG. 4 is a diagram illustrating a specific example of the image processing performed by the image processing device.

As illustrated in FIG. 4, when the filter processing unit 320 notifies the image recognition unit 330 of frame data to be processed 400 in the image processing device 121, the image recognition unit 330 performs an image recognition process on the frame data to be processed 400. A reference numeral 401 indicates a state in which the image recognition unit 330 performs the image recognition process on the frame data to be processed 400 to recognize an object. As a result, the evaluation unit 340 notifies the invalidated video generation unit 360 of the area other than the object area.

Furthermore, as described above, in the image processing device 121, the filter processing unit 320 sequentially performs the filtering processing on the frame data to be processed 400 using individual setting filters sequentially set by the filter setting unit 310. Furthermore, the image recognition unit 330 sequentially performs the image recognition process on the individual pieces of processed frame data.

The example of FIG. 4 indicates that the filter processing unit 320 performs the filtering processing on the frame data to be processed 400 using the setting filter having the processing strength equivalent to QP₃₅ (setting filter corresponding to QP₃₅) to generate processed frame data 410. Furthermore, the example of FIG. 4 indicates that the image recognition unit 330 performs the image recognition process on the processed frame data 410 to output a recognition result 411 and the evaluation unit 340 determines that the object recognition accuracy has sharply dropped.

Note that a graph 430 in FIG. 4 illustrates a change in the object recognition accuracy when the individual setting filters are sequentially set in the filter processing unit 320. As illustrated in the graph 430, the object recognition accuracy sharply drops with the setting filter corresponding to QP₃₅ as a boundary.

Accordingly, in the example of FIG. 4, the evaluation unit 340 identifies the setting filter (e.g., setting filter corresponding to QP₃₄) notified at the timing immediately before the sharp drop of the recognition accuracy, and notifies the quantization step conversion unit 350 of it.

As a result, as illustrated in FIG. 4, the quantization step conversion unit 350 notifies the control device 122 of QP₃₄ as the first quantization step.

<Functional Configuration of Control Device>

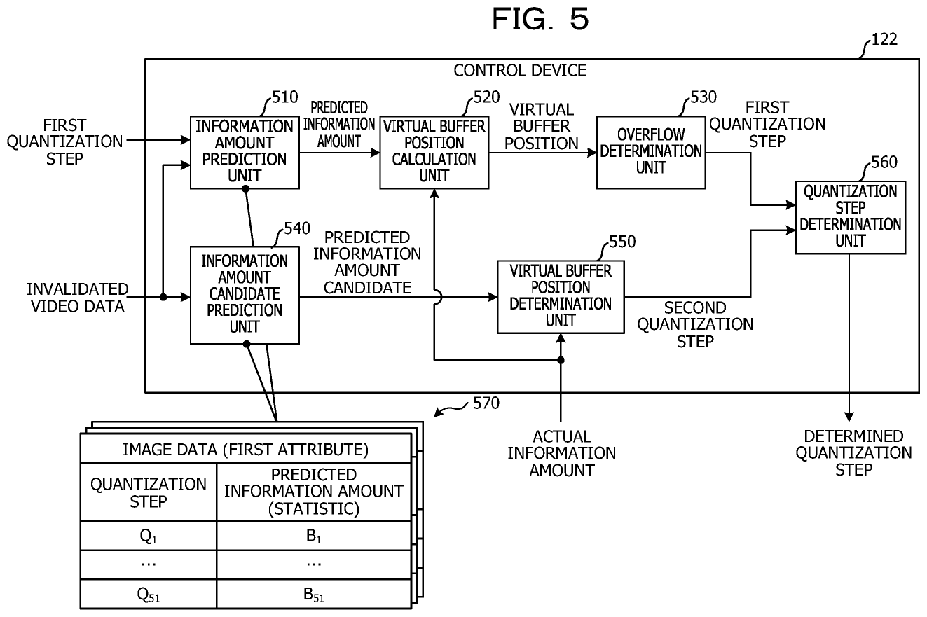

Next, a functional configuration of the control device 122 in the bit rate control system 120 will be described. FIG. 5 is a first diagram illustrating an exemplary functional configuration of the control device. As described above, the bit rate control program is installed in the bit rate control system 120, and with the program being executed, the control device 122 in the bit rate control system 120 functions as the following units:
Information amount prediction unit 510;
Virtual buffer position calculation unit 520;
Overflow determination unit 530;
Information amount candidate prediction unit 540;
Virtual buffer position determination unit 550; and
Quantization step determination unit 560.

Among those units, the information amount prediction unit 510 is an exemplary prediction unit, and specifies an information amount (predicted information amount) of encoded data in the case where the encoding processing is performed on the frame data to be processed using the first quantization step among the individual pieces of frame data of the invalidated video data.

Note that, as illustrated in FIG. 5, the information amount prediction unit 510 has a statistical information amount 570 (table that stores, as predicted information amounts, statistics of the information amount of the encoded data in the case where the encoding processing is performed on image data of individual attributes using the individual quantization steps) in advance.

Thus, the information amount prediction unit 510 refers to the statistical information amount 570 to specify the predicted information amount (statistic) of the image data of the attribute corresponding to the attribute of the frame data to be processed, which is the predicted information amount (statistic) of the quantization step corresponding to the first quantization step.

The virtual buffer position calculation unit 520 calculates a current virtual buffer position based on the actual information amount obtained from the encoder 130. Furthermore, the virtual buffer position calculation unit 520 predicts a change of the virtual buffer position in the case where the encoding processing is performed on the frame data to be processed using the first quantization step based on the calculated current virtual buffer position and the predicted information amount specified by the information amount prediction unit 510.

The overflow determination unit 530 is an exemplary determination unit, and determines whether or not overflow occurs based on the prediction result of the changed virtual buffer position predicted by the virtual buffer position calculation unit 520. Furthermore, when the overflow determination unit 530 determines that no overflow occurs, it notifies the quantization step determination unit 560 of the first quantization step. Note that, the overflow determination unit 530 does not notify the quantization step determination unit 560 of the first quantization step when it determines that overflow occurs.

The information amount candidate prediction unit 540 specifies a predicted information amount candidate in the case where the encoding processing is performed on the frame data to be processed among the individual pieces of frame data of the invalidated video data notified from the image processing device 121.

Note that, as illustrated in FIG. 5, the information amount candidate prediction unit 540 has the statistical information amount 570 in advance in a similar manner to the information amount prediction unit 510. Thus, the information amount candidate prediction unit 540 refers to the statistical information amount 570 to specify, as predicted information amount candidates, all the predicted information amounts (statistics) of the image data of the attribute corresponding to the attribute of the frame data to be processed.

The virtual buffer position determination unit 550 calculates a current virtual buffer position based on the actual information amount obtained from the encoder 130. Furthermore, the virtual buffer position determination unit 550 determines a target virtual buffer position that does not cause overflow in the virtual buffer. Furthermore, the virtual buffer position determination unit 550 specifies the predicted information amount equivalent to the difference between the determined target virtual buffer position and the calculated current virtual buffer position from among the predicted information amount candidates. Moreover, the virtual buffer position determination unit 550 identifies the quantization step corresponding to the predicted information amount specified from among the predicted information amount candidates as the second quantization step, and notifies the quantization step determination unit 560 of it.

The quantization step determination unit 560 is an exemplary control unit, and determines to use the first quantization step at the time of performing the encoding processing on the frame data to be processed when it is notified of the first quantization step by the overflow determination unit 530. Furthermore, the quantization step determination unit 560 determines to use the second quantization step at the time of performing the encoding processing on the frame data to be processed when it is not notified of the first quantization step by the overflow determination unit 530.

Moreover, the quantization step determination unit 560 notifies the encoder 130 of the quantization step that has been determined (determined quantization step).

<Flow of Bit Rate Control Process>

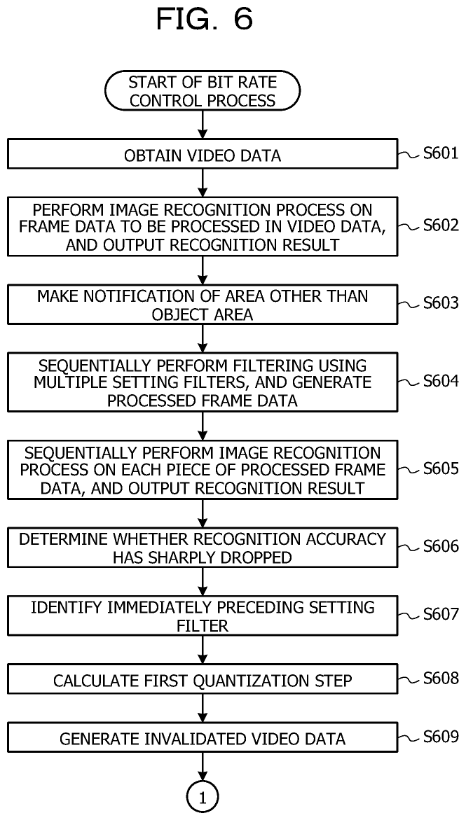

Next, a flow of a bit rate control process performed by the bit rate control system 120 will be described. FIG. 6 is a first flowchart illustrating a flow of the bit rate control process.

In step S601, the filter processing unit 320 of the image processing device 121 obtains video data.

In step S602, the image recognition unit 330 of the image processing device 121 performs an image recognition process on the frame data to be processed among individual pieces of frame data of the video data, and outputs a recognition result.

In step S603, the evaluation unit 340 of the image processing device 121 specifies the area other than the object area in the frame data to be processed based on the recognition result, and notifies the invalidated video generation unit 360 of it.

In step S604, the filter setting unit 310 of the image processing device 121 sequentially sets multiple setting filters having different levels of processing strength in the filter processing unit 320, and notifies the evaluation unit 340 of them. Furthermore, the filter processing unit 320 of the image processing device 121 sequentially performs filtering processing on the frame data to be processed using the set multiple setting filters, and generate individual pieces of processed frame data.

In step S605, the image recognition unit 330 of the image processing device 121 sequentially performs the image recognition process on the individual pieces of processed frame data, and outputs individual recognition results.

In step S606, the evaluation unit 340 of the image processing device 121 monitors the object recognition accuracy in the recognition results sequentially notified from the image recognition unit 330, and determines whether the object recognition accuracy has sharply dropped.

In step S607, the evaluation unit 340 of the image processing device 121 identifies the setting filter notified from the filter setting unit 310 at the timing immediately before the sharp drop of the object recognition accuracy.

In step S608, the quantization step conversion unit 350 of the image processing device 121 calculates the first quantization step, which is the quantization step corresponding to the identified setting filter.

In step S609, the invalidated video generation unit 360 of the image processing device 121 invalidates the area other than the object area for the frame data to be processed, thereby generating invalidated video data.

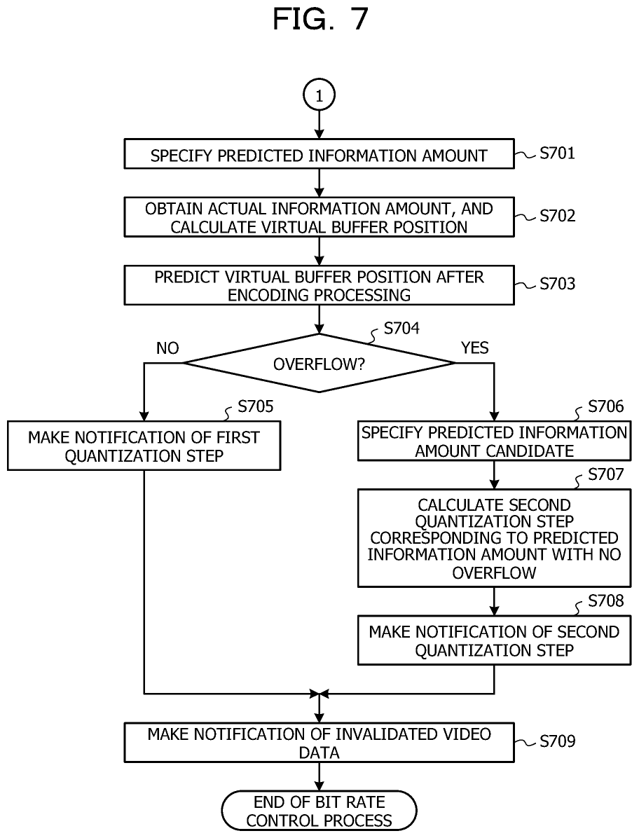

Subsequently, in step S701 in FIG. 7, the information amount prediction unit 510 of the control device 122 specifies the predicted information amount in the case where encoding processing is performed on the frame data to be processed in the invalidated video data using the first quantization step.

In step S702, the virtual buffer position calculation unit 520 of the control device 122 obtains, from the encoder 130, the actual information amount, which is the information amount of the encoded data when the encoding processing is performed on the previous processing target frame data, and calculates the current virtual buffer position.

In step S703, the virtual buffer position calculation unit 520 of the control device 122 predicts a change of the virtual buffer position in the case where the encoding processing is performed on the frame data to be processed using the first quantization step based on the specified predicted information amount.

In step S704, the overflow determination unit 530 of the control device 122 determines whether or not overflow occurs based on the prediction result of the changed virtual buffer position. If it is determined that no overflow occurs in step S704 (in the case of NO in step S704), the process proceeds to step S705.

In step S705, the overflow determination unit 530 of the control device 122 notifies the quantization step determination unit 560 of the first quantization step, and the quantization step determination unit 560 notifies the encoder 130 of the first quantization step as a determined quantization step.

On the other hand, if it is determined that overflow occurs in step S704 (in the case of YES in step S704), the process proceeds to step S706.

In step S706, the information amount candidate prediction unit 540 of the control device 122 specifies a predicted information amount candidate in the case where the encoding processing is performed on the frame data to be processed in the invalidated video data.

In step S707, the virtual buffer position determination unit 550 of the control device 122 obtains, from the encoder 130, the actual information amount, which is the information amount of the encoded data when the encoding processing is performed on the previous processing target frame data, and calculates the current virtual buffer position. Furthermore, the virtual buffer position determination unit 550 of the control device 122 determines a target virtual buffer position that does not cause overflow in the virtual buffer, and specifies the predicted information amount that satisfies the determined target virtual buffer position from among the predicted information amount candidates. Moreover, the virtual buffer position determination unit 550 identifies the second quantization step corresponding to the specified predicted information amount.

In step S708, the virtual buffer position determination unit 550 of the control device 122 notifies the quantization step determination unit 560 of the second quantization step, and the quantization step determination unit 560 notifies the encoder 130 of the second quantization step as a determined quantization step.

In step S709, the invalidated video generation unit 360 of the image processing device 121 notifies the encoder 130 of the frame data to be processed in the invalidated video data.

As a result, the encoder 130 is enabled to perform the encoding processing on the frame data to be processed in the invalidated video data using the determined quantization step.

<Exemplary Transition of Virtual Buffer Position>

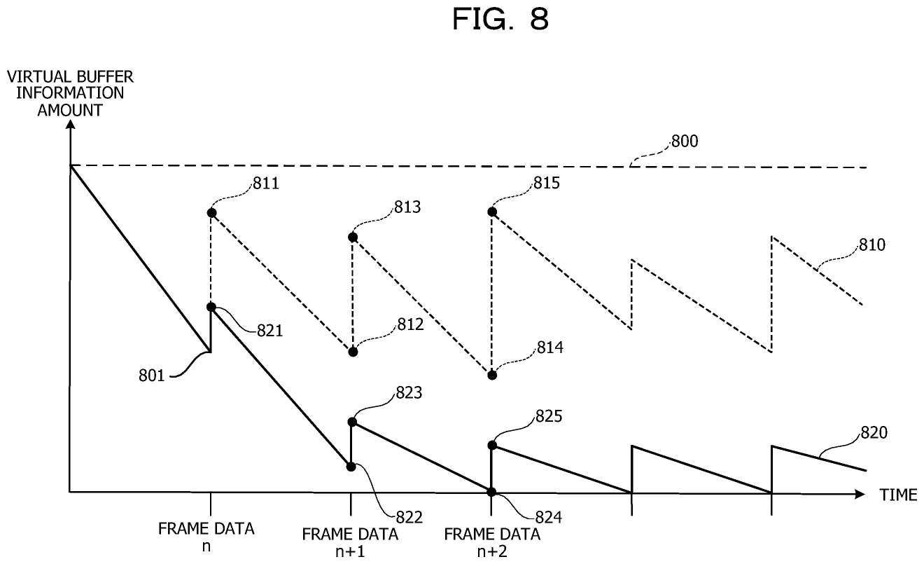

Next, exemplary transition of the virtual buffer position that transitions due to the bit rate control process performed by the bit rate control system 120 will be described. FIG. 8 is a diagram illustrating exemplary transitions of the virtual buffer position. In FIG. 8, the horizontal axis represents a time, the vertical axis represents an information amount of the virtual buffer viewed from the encoder 130, and it is indicated that occurrence of overflow is determined when a predicted virtual buffer position exceeds a reference numeral 800.

Of the graphs illustrated in FIG. 8, a dotted line graph 810 represents transition of the virtual buffer position when an existing bit rate control process is performed. It is assumed that, as indicated by the dotted line graph 810, frame data having been subject to encoding processing (encoded data) is transmitted, and the encoding processing is performed on frame data n at the timing when the virtual buffer position transitions to the position indicated by a reference numeral 801. As described above, according to the existing bit rate control process, encoding processing is carried out in such a manner that image quality of frame data is maintained to a maximum extent within a range in which no overflow occurs, and thus the virtual buffer position transitions to a reference numeral 811.

Furthermore, it is assumed that the frame data n having been subject to the encoding processing (encoded data) is transmitted, and the encoding processing is performed on frame data (n+1) at the timing when the virtual buffer position transitions to the position indicated by a reference numeral 812. As a result, the virtual buffer position transitions to a reference numeral 813.

Furthermore, it is assumed that the frame data (n+1) having been subject to the encoding processing (encoded data) is transmitted, and the encoding processing is performed on frame data (n+2) at the timing when the virtual buffer position transitions to the position indicated by a reference numeral 814. As a result, the virtual buffer position transitions to a reference numeral 815.

Thereafter, similar processing is repeated, and the virtual buffer position transitions within the range in which no overflow occurs as time passes in the case of the existing bit rate control process (see graph 810).

On the other hand, of the graphs illustrated in FIG. 8, a solid line graph 820 represents transition of the virtual buffer position when the bit rate control system 120 performs the bit rate control process and the first quantization step is notified by the control device 122 as a determined quantization step. It is assumed that, as indicated by the solid line graph 820, frame data having been subject to the encoding processing (encoded data) is transmitted, and the encoding processing is performed on the frame data n at the timing when the virtual buffer position transitions to the position indicated by the reference numeral 801. As described above, the first quantization step corresponds to the image quality at which the recognition accuracy reaches the allowable limit. Accordingly, the information amount of the encoded data in the case where the encoding processing is performed using the first quantization step is less than the information amount of the encoded data in the case where the encoding processing is performed such that the image quality is maintained to the maximum extent. As a result, the virtual buffer position transitions to a reference numeral 821.

Furthermore, it is assumed that the frame data n having been subject to the encoding processing (encoded data) is transmitted, and the encoding processing is performed on the frame data (n+1) at the timing when the virtual buffer position transitions to the position indicated by a reference numeral 822. Note that, it is also assumed here that the first quantization step is used. In this case, the virtual buffer position transitions to a reference numeral 823.

Furthermore, it is assumed that the frame data (n+1) having been subject to the encoding processing (encoded data) is transmitted, and the encoding processing is performed on the frame data (n+2) at the timing when the virtual buffer position transitions to the position indicated by a reference numeral 824. Note that, it is also assumed here that the first quantization step is used. In this case, the virtual buffer position transitions to a reference numeral 825.

Thereafter, similar processing is repeated, and the virtual buffer position transitions while it is maintained at a low level as time passes in the case of the existing bit rate control process performed by the bit rate control system 120 (see graph 820).

In this manner, according to the bit rate control system 120 according to the first embodiment, it becomes possible to achieve bit rate control suitable for the image recognition process using AI.

<Functional Configuration of Encoder>

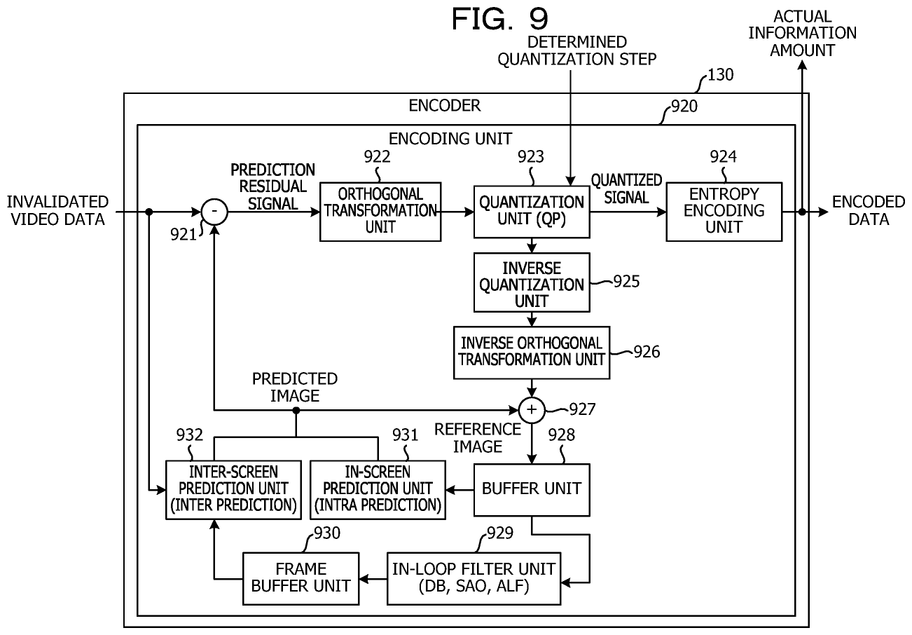

Next, a functional configuration of the encoder 130 will be described. FIG. 9 is a diagram illustrating an exemplary functional configuration of the encoder. An encoding program is installed in the encoder 130, and with the program being executed, the encoder 130 functions as an encoding unit 920.

The encoding unit 920 includes a difference unit 921, an orthogonal transformation unit 922, a quantization unit 923, an entropy encoding unit 924, an inverse quantization unit 925, and an inverse orthogonal transformation unit 926. Furthermore, the encoding unit 920 includes an addition unit 927, a buffer unit 928, an in-loop filter unit 929, a frame buffer unit 930, an in-screen prediction unit 931, and an inter-screen prediction unit 932.

The difference unit 921 calculates a difference between invalidated video data (e.g., invalidated video data 370) and predicted image data, and outputs a prediction residual signal.

The orthogonal transformation unit 922 performs orthogonal transformation processing on the prediction residual signal output from the difference unit 921.

The quantization unit 923 quantizes the prediction residual signal on which the orthogonal transformation processing has been performed, and generates a quantized signal. The quantization unit 923 generates the quantized signal using a determined quantization step.

The entropy encoding unit 924 generates encoded data by performing entropy encoding processing on the quantized signal. Note that the information amount of the generated encoded data is notified to the control device 122 as the actual information amount.

The inverse quantization unit 925 inversely quantizes the quantized signal. The inverse orthogonal transformation unit 926 performs inverse orthogonal transformation processing on the quantized signal that has been inversely quantized.

The addition unit 927 adds a signal output from the inverse orthogonal transformation unit 926 and the predicted image data, thereby generating reference image data. The buffer unit 928 stores the reference image data generated by the addition unit 927.

The in-loop filter unit 929 performs filtering processing on the reference image data stored in the buffer unit 928. The in-loop filter unit 929 includes the following items:
Deblocking filter (DB);
Sample adaptive offset filter (SAO); and
Adaptive loop filter (ALF).

The frame buffer unit 930 stores, in frame units, the reference image data having been subject to the filtering processing performed by the in-loop filter unit 929.

The in-screen prediction unit 931 performs in-screen prediction based on the reference image data, and generates predicted image data. The inter-screen prediction unit 932 performs motion compensation between frames using input image data (e.g., invalidated video data 370) and the reference image data, and generates the predicted image data.

Note that the predicted image data generated by the in-screen prediction unit 931 or the inter-screen prediction unit 932 is output to the difference unit 921 and the addition unit 927.

Note that, in the descriptions above, it is assumed that the encoding unit 920 performs the encoding processing using an existing moving image encoding scheme such as MPEG-2, MPEG-4, H.264, HEVC, or the like. However, the encoding processing performed by the encoding unit 920 is not limited to those moving image encoding schemes, and may be performed using any moving image encoding scheme in which a compression rate is controlled by parameters such as a quantization step.

As is clear from the descriptions above, the bit rate control system according to the first embodiment performs the image recognition process on the frame data to be processed in the video data while changing the image quality. As a result, the bit rate control system according to the first embodiment specifies the image quality at which the recognition accuracy of the object included in the frame data to be processed reaches the allowable limit, and calculates the first quantization step corresponding to the specified image quality.

Furthermore, the bit rate control system according to the first embodiment predicts a change of the virtual buffer position in the case where the encoding processing is performed on the frame data to be processed using the calculated first quantization step, and determines whether or not overflow occurs in the virtual buffer.

Moreover, the bit rate control system according to the first embodiment exercise control to perform the encoding processing on the frame to be processed using the calculated first quantization step when it is determined that no overflow occurs.

As a result, according to the bit rate control system according to the first embodiment, it becomes possible to achieve bit rate control suitable for the image recognition process using AI.

### Second Embodiment

In the first embodiment described above, details of the information amount prediction unit 510 of the control device 122 have not been mentioned. Meanwhile, in a second embodiment, details of an information amount prediction unit will be described.

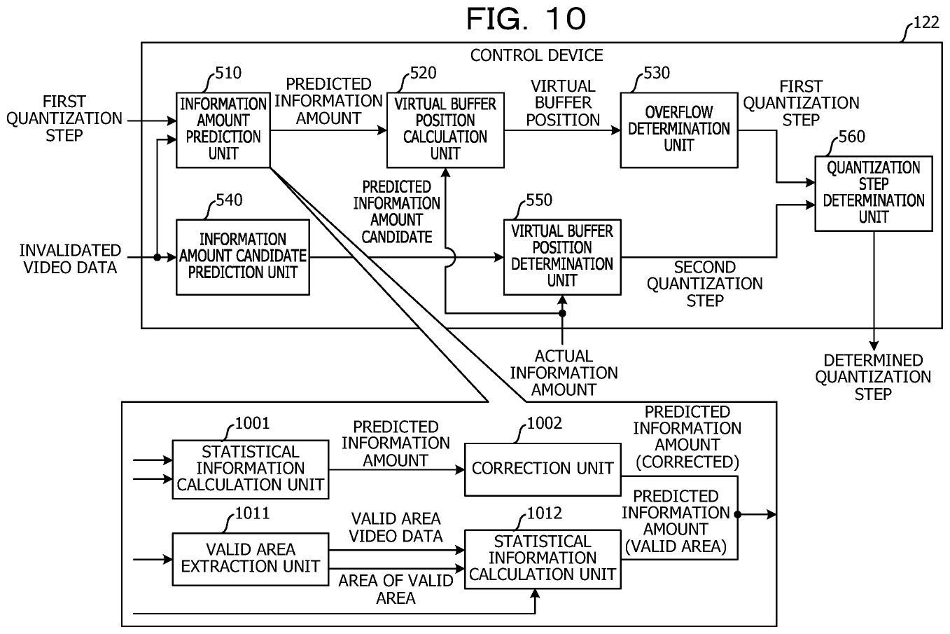

FIG. 10 is a diagram illustrating details of an information amount prediction unit of a control device. As illustrated in FIG. 10, an information amount prediction unit 510 includes a statistical information calculation unit 1001, a correction unit 1002, a valid area extraction unit 1011, and a statistical information calculation unit 1012.

The statistical information calculation unit 1001 and the correction unit 1002 specify a predicted information amount in the case where an encoder 130 performs encoding processing based on inter-screen prediction (inter prediction).

For example, the statistical information calculation unit 1001 specifies the predicted information amount based on a statistical information amount (e.g., statistical information amount 570) for frame data to be processed in invalidated video data. Furthermore, the correction unit 1002 makes a correction using the information amount (actual information amount) of encoded data when the encoding processing based on the inter prediction is performed on frame data close to the frame data to be processed among the pieces of past frame data having been subject to the encoding processing based on the inter prediction.

Meanwhile, the valid area extraction unit 1011 and the statistical information calculation unit 1012 specify the predicted information amount in the case where an encoder 130 performs the encoding processing based on in-screen prediction (intra prediction).

For example, the valid area extraction unit 1011 extracts, as a valid area, an object area from the frame data to be processed in the invalidated video data, and notifies the statistical information calculation unit 1012 of valid area video data. Furthermore, the valid area extraction unit 1011 calculates the area of the extracted valid area, and notifies the statistical information calculation unit 1012 of it. Furthermore, the statistical information calculation unit 1012 specifies the predicted information amount based on the statistical information amount (e.g., statistical information amount 570 limited to the valid area) for the frame data to be processed among the pieces of valid area video data while taking into account the area of the valid area.

Note that, while the statistical information calculation units 1001 and 1012 specify the predicted information amount using the statistical information amount stored in advance (e.g., statistical information amount 570, etc.) in the second embodiment, the statistical information amount may be updated by a training function, for example. For example, the statistical information amount may be updated based on the difference between the predicted information amount specified using the statistical information amount stored in advance and the information (actual information amount) of the encoded data when the encoding processing is actually performed.

Furthermore, in the descriptions of the second embodiment, different processing is performed on the frame data to be subject to the encoding processing based on the inter-screen prediction (inter prediction) and the frame data to be subject to the encoding processing based on the in-screen prediction (intra prediction).

However, when a new object appears in the frame data to be subject to the encoding processing based on the inter prediction, the area of the new object may be processed in a similar manner to the frame data to be subject to the encoding processing based on the intra prediction.

### Third Embodiment

In the descriptions of the first embodiment described above, when the encoding processing is performed using the first quantization step to determine that overflow occurs, the encoding processing is performed using the second quantization step to avoid the overflow occurrence.

Meanwhile, in a third embodiment, when encoding processing is performed using a first quantization step to determine that overflow occurs, a frame rate is lowered to avoid the overflow occurrence. Hereinafter, the third embodiment will be described focusing on differences from the first embodiment described above.

<System Configuration of Video Transmission System>

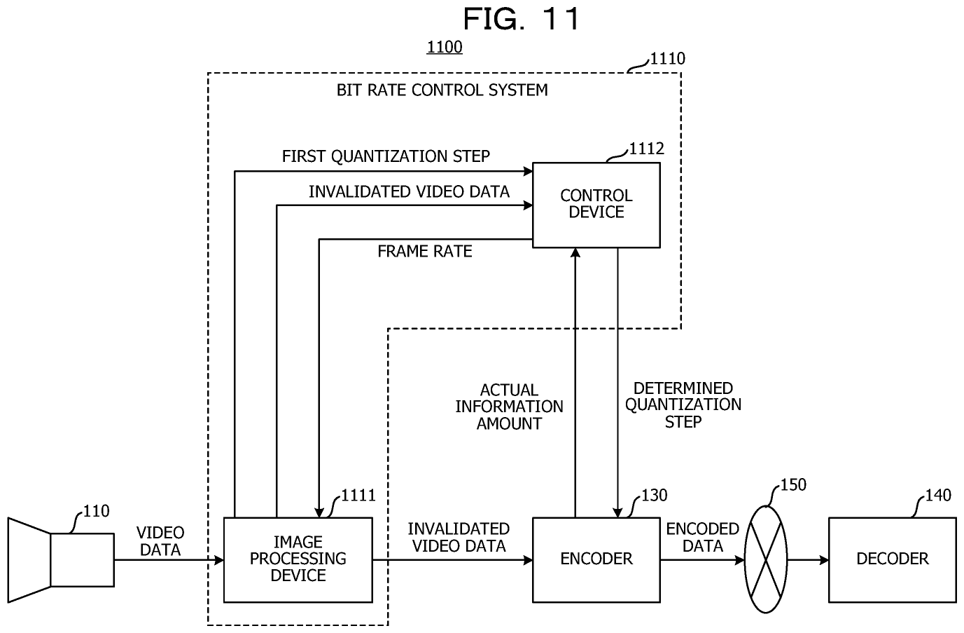

First, a system configuration of an entire video transmission system including a bit rate control system according to a third embodiment will be described. FIG. 11 is a second diagram illustrating an exemplary system configuration of the video transmission system.

A difference from FIG. 1 is that functions of a bit rate control system 1110 are different from the functions of the bit rate control system 120. As illustrated in FIG. 11, the bit rate control system 1110 includes an image processing device 1111 and a control device 1112.

The image processing device 1111 performs an image recognition process on frame data to be processed in video data, thereby specifying an object area included in the frame data to be processed and an area other than the object area. Furthermore, the image processing device 1111 notifies a control device 1112 of invalidated video data in which the area other than the object area is invalidated.

Furthermore, the image processing device 1111 performs the image recognition process on the frame data to be processed in the video data while changing the image quality, thereby specifying the image quality at which recognition accuracy of an object included in the frame data to be processed reaches an allowable limit. Furthermore, the image processing device 1111 calculates the first quantization step corresponding to the specified image quality. Moreover, the image processing device 1111 notifies the control device 1112 of the calculated first quantization step.

Furthermore, when the image processing device 1111 is notified of a frame rate by the control device 1112 in response to the notification to the control device 1112 regarding the first quantization step, it notifies an encoder 130 of the invalidated video data according to the frame rate.

The control device 1112 obtains, from the encoder 130, the information amount (actual information amount) of encoded data measured when the encoder 130 performs the encoding processing on the previous processing target frame data of the invalidated video data.

Furthermore, the control device 1112 calculates a current virtual buffer position based on the obtained actual information amount, and predicts a change of the virtual buffer position when the encoding processing is performed on the frame data to be processed using the first quantization step.

Furthermore, the control device 1112 determines whether or not overflow occurs in a virtual buffer based on the prediction result of the changed virtual buffer position. Furthermore, when the control device 1112 determines that no overflow occurs, it determines to perform the encoding processing on the frame data to be processed using the first quantization step without changing the frame rate.

Furthermore, when the control device 1112 determines that overflow occurs, it calculates a frame rate at which the overflow occurrence may be avoided based on the calculated current virtual buffer position. Furthermore, the control device 1112 notifies the image processing device 1111 of the calculated frame rate, and determines to perform the encoding processing using the first quantization step.

Moreover, the control device 1112 notifies the encoder 130 of the first quantization step as a determined quantization step. As a result, the control device 1112 is enabled to control the encoder 130 to perform, using the first quantization step, the encoding processing on the invalidated video data whose frame rate has been changed.

<Functional Configuration of Image Processing Device>

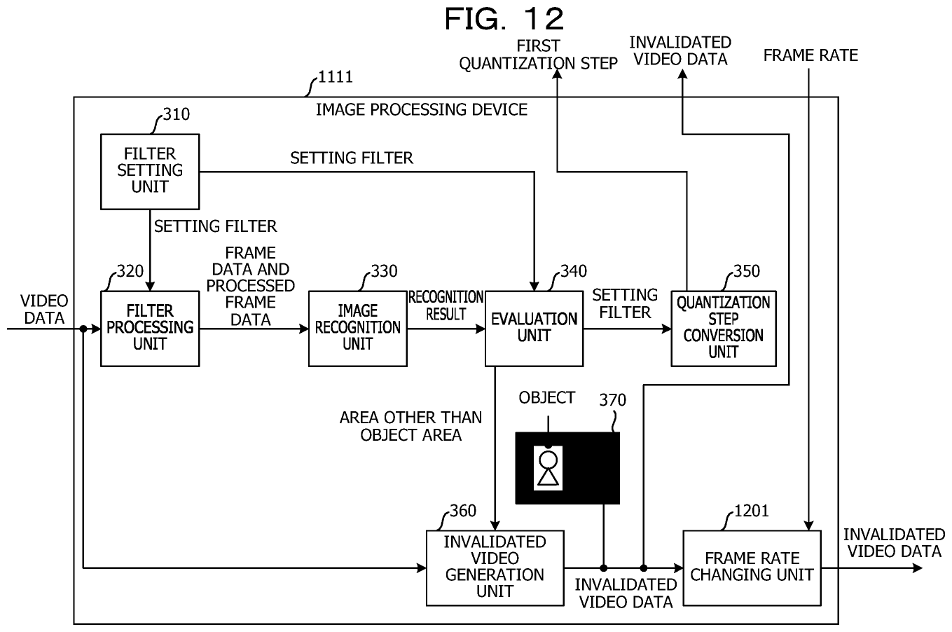

Next, a functional configuration of the image processing device 1111 in the bit rate control system 1110 will be described. FIG. 12 is a second diagram illustrating an exemplary functional configuration of the image processing device. A difference from the image processing device 121 described with reference to FIG. 3 is that a frame rate changing unit 1201 is included.

The frame rate changing unit 1201 obtains the invalidated video data output from an invalidated video generation unit 360, and decimates frame data according to the frame rate notified from the control device 1112. Furthermore, the frame rate changing unit 1201 notifies the encoder 130 of the invalidated video data in which the frame data is decimated according to the frame rate.

<Functional Configuration of Control Device>

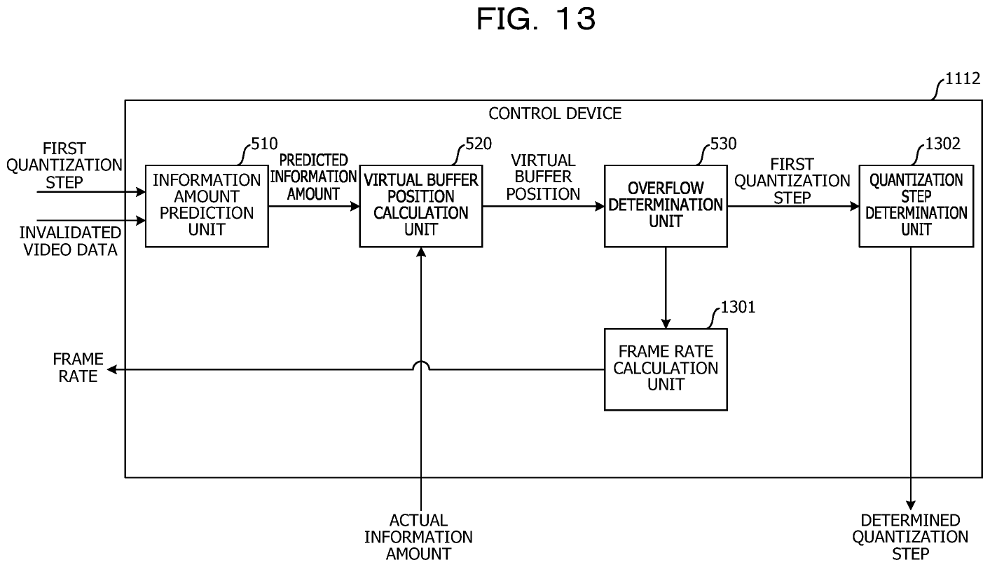

Next, a functional configuration of the control device 1112 in the bit rate control system 1110 will be described. FIG. 13 is a second diagram illustrating an exemplary functional configuration of the control device. Differences from the control device 122 illustrated in FIG. 5 are that a frame rate calculation unit 1301 is included and a function of a quantization step determination unit 1302 is different from the function of the quantization step determination unit 560.

The frame rate calculation unit 1301 is an exemplary second calculation unit, and calculates a frame rate at which overflow occurrence may be avoided when an overflow determination unit 530 determines that overflow occurs. Furthermore, the frame rate calculation unit 1301 notifies the image processing device 1111 of the calculated frame rate.

The quantization step determination unit 1302 determines the first quantization step notified from the overflow determination unit 530 as a quantization step to be used to perform the encoding processing on the frame data to be processed. Furthermore, the quantization step determination unit 1302 notifies the encoder 130 of the determined quantization step.

<Flow of Bit Rate Control Process>

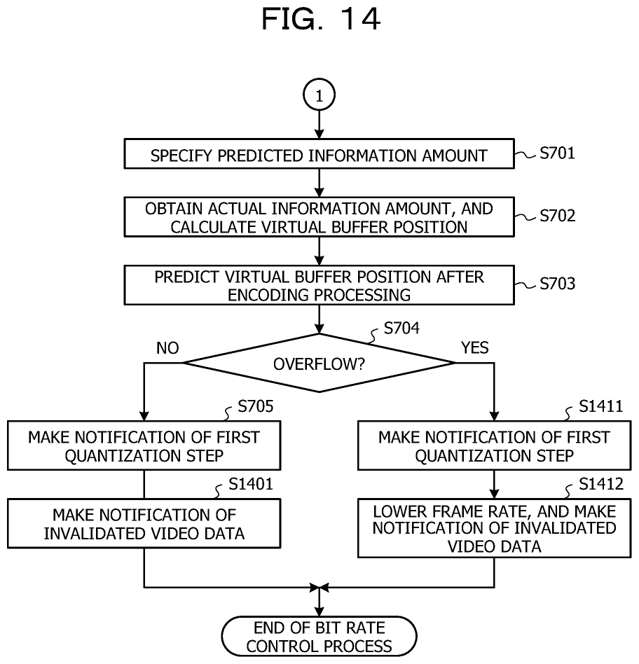

Next, a flow of a bit rate control process performed by the bit rate control system 1110 will be described. The bit rate control system 1110 executes flowcharts illustrated in FIGS. 6 and 14 instead of the flowcharts illustrated in FIGS. 6 and 7. Thus, hereinafter, the flowchart illustrated in FIG. 14 will be described.

FIG. 14 is a third flowchart illustrating a flow of the bit rate control process. Note that differences from the second flowchart illustrated in FIG. 7 are steps S1401, S1411, and S1412.

In step S1401, the frame rate changing unit 1201 of the image processing device 1111 notifies the encoder 130 of the invalidated video data without changing the frame rate.

In step S1411, the overflow determination unit 530 of the control device 1112 notifies the quantization step determination unit 1302 of the first quantization step, and the quantization step determination unit 1302 notifies the encoder 130 of the first quantization step.

In step S1412, the frame rate calculation unit 1301 of the control device 1112 calculates a frame rate at which overflow occurrence may be avoided, and notifies the frame rate changing unit 1201 of the image processing device 1111 of it. Furthermore, the frame rate changing unit 1201 of the image processing device 1111 notifies the encoder 130 of the invalidated video data in which the frame data is decimated according to the notified frame rate.

As is clear from the descriptions above, the bit rate control system according to the third embodiment performs the image recognition process on the frame data to be processed in the video data while changing the image quality. As a result, the bit rate control system according to the third embodiment specifies the image quality at which the recognition accuracy of the object included in the frame data to be processed reaches the allowable limit, and calculates the first quantization step corresponding to the specified image quality.

Furthermore, the bit rate control system according to the third embodiment predicts a change of the virtual buffer position in the case where the encoding processing is performed on the frame data to be processed using the calculated first quantization step, and determines whether or not overflow occurs in the virtual buffer.

Furthermore, the bit rate control system according to the third embodiment calculates a frame rate at which overflow occurrence may be avoided when it is determined that overflow occurs. Moreover, the bit rate control system according to the third embodiment exercise control to perform the encoding processing on the invalidated video data according to the calculated frame rate using the calculated first quantization step.

As a result, according to the bit rate control system according to the third embodiment, it becomes possible to achieve bit rate control suitable for the image recognition process using AI.

### Other Embodiments

In the descriptions of each of the embodiments described above, the invalidated video generation unit generates invalidated video data to notify the control device and the encoder of it in the image processing device. However, the image processing device may notify the control device and the encoder of video data. In this case, the control device specifies a predicted information amount or a predicted information amount candidate based on the frame data of the video data. Furthermore, the encoder performs the encoding processing on the frame data of the video data.

Furthermore, although the frame data decimated by the frame rate changing unit 1201 from the invalidated video data has not been mentioned in the third embodiment described above, the frame rate changing unit 1201 may decimate the frame data to be processed, for example. Alternatively, the frame data to be processed and the frame data to be processed next time may be decimated. For example, the frame data to be decimated from the invalidated video data is not limited to one, and a plurality of pieces thereof may be decimated.

Furthermore, although overflow occurrence is avoided by changing the frame rate to increase the permissible value of the information amount that may be allocated to each frame in the third embodiment described above, the method for avoiding the overflow occurrence is not limited to this, and another method may be used. Alternatively, a plurality of those methods for avoiding the overflow occurrence may be applied in combination. For example, methods for reducing color information, changing resolution, and the like may be applied in combination.

Note that the embodiments are not limited to the configurations described here, and may include combinations of the configurations or the like described in the embodiments above with other elements, and the like. Those points may be changed without departing from the spirit of the embodiments, and may be appropriately defined according to application modes thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A bit rate control system comprising:
a memory; and
a processor coupled to the memory and configured to:
perform an image recognition process on a frame to be processed in video while changing image quality to specify the image quality at which recognition accuracy of an object included in the frame to be processed reaches an allowable limit;
calculate a first quantization step that corresponds to the specified image quality;
determine whether or not overflow occurs in a virtual buffer when encoding processing is performed on the frame to be processed by using the calculated first quantization step; and
exercise control to perform the encoding processing on the frame to be processed by using the calculated first quantization step when the overflow is determined not to occur.

2. The bit rate control system according to claim 1, wherein the processor exercises the control to perform the encoding processing on the frame to be processed by using a second quantization step that avoids occurrence of the overflow when the overflow is determined to occur.

3. The bit rate control system according to claim 1, wherein the processor:
calculates a frame rate that avoids occurrence of the overflow when the overflow is determined to occur; and
exercises the control to perform the encoding processing by using the calculated first quantization step at the calculated frame rate.

4. The bit rate control system according to claim 1, wherein the processor:
predicts an information amount when the encoding processing is performed on the frame to be processed by using the calculated first quantization step; and determines whether or not the overflow occurs in the virtual buffer based on the information amount.

5. The bit rate control system according to claim 4, wherein the processor predicts the information amount for an area of the object included in the frame to be processed.

6. The bit rate control system according to claim 5, wherein the processor predicts the information amount according to an area of the area of the object included in the frame to be processed.

7. The bit rate control system according to claim 4, wherein the processor predicts the information amount based on a statistical information amount stored in advance or based on the statistical information amount trained based on a difference between a predicted information amount and an actual information amount.

8. A bit rate control method comprising:
performing an image recognition process on a frame to be processed in video while changing image quality to specify the image quality at which recognition accuracy of an object included in the frame to be processed reaches an allowable limit;
calculating a first quantization step that corresponds to the specified image quality;
determining whether or not overflow occurs in a virtual buffer when encoding processing is performed on the frame to be processed by using the calculated first quantization step; and
exercising control to perform the encoding processing on the frame to be processed by using the calculated first quantization step when the overflow is determined not to occur.

9. A non-transitory computer readable recording medium storing a bit rate control program causing a computer to execute a processing of:
performing an image recognition process on a frame to be processed in video while changing image quality to specify the image quality at which recognition accuracy of an object included in the frame to be processed reaches an allowable limit;
calculating a first quantization step that corresponds to the specified image quality;
determining whether or not overflow occurs in a virtual buffer when encoding processing is performed on the frame to be processed by using the calculated first quantization step; and
exercising control to perform the encoding processing on the frame to be processed by using the calculated first quantization step when the overflow is determined not to occur.
